(19) United States
(12) Patent Application Publication
(10) Pub. No.: US 2014/0213207 A1
(43) Pub. Date: Jul. 31, 2014

(54) METHOD AND APPARATUS FOR COMPENSATING FOR FREQUENCY OFFSET

(71) Applicant: ELECTRONICS AND TELECOMMUNICATIONS RESEARCH INSTITUTE, Daejeon-si (KR)

(72) Inventors: Ho Min EUM, Daejeon (KR); Heung Mook KIM, Daejeon (KR)

(73) Assignee: ELECTRONICS AND TELECOMMUNICATIONS RESEARCH INSTITUTE, Daejeon-si (KR)

(21) Appl. No.: 14/145,131

(22) Filed: Dec. 31, 2013

(30) Foreign Application Priority Data
Jan. 31, 2013 (KR) 10-2013-0011468

(51) Int. Cl. H04B 1/12

(52) U.S. Cl. CPC H04B 1/12
USPC 455/226.1

(57) ABSTRACT

The present invention provides a method and apparatus for compensating for a frequency offset. The apparatus for compensating for a frequency offset includes a signal processing unit configured to receive a first frequency signal from a GPS receiver, a local oscillator configured to transfer a second frequency signal to the GPS receiver so that the first frequency signal is generated, and a frequency offset compensation unit configured to receive frequency offset information, obtained when the first frequency signal is generated, from the GPS receiver and remove a frequency offset component of the local oscillator based on the frequency offset information.

Priority to Korean patent application number 2013-0011468 filed on Jan. 31, 2013, the entire disclosure of which is incorporated by reference herein, is claimed.

### BACKGROUND OF THE INVENTION

1. Field of the Invention

The present invention relates to a method and apparatus for compensating for a frequency offset and, more particularly, to a method and apparatus for compensating for a frequency offset in order to make transmission signals from a plurality of transmitters within a service network have the same frequency.

2. Discussion of the Related Art

In general, in a service network including a plurality of transmitters, transmission signals transmitted by the respective transmitters are made to have the same frequency. In this case, there is a need for a common reference signal, that is, a frequency reference for all the transmitters within the service network, and a Global Positioning System (GPS) signal is used as a representative reference signal.

A GPS sends various reference signals, such a 10 MHz and 1 PPS, and each transmitter generates a reference frequency by restoring the reference signal. The generated reference frequency is used in analog/digital conversion, digital/analog conversion, and frequency up- or down-conversion.

A representative example in which frequencies within a service network are made to coincide with each other using a GPS signal includes a terrestrial wave broadcasting network. In terrestrial broadcasting networks, such as Advanced Television System Committee (ATSC) and Digital Video Broadcasting-Terrestrial (DVB-T), frequency use efficiency is increased by constructing a single frequency network. The single frequency network is a broadcasting network for making coincident with each other the frequencies of broadcasting signals between transmitters which send the same content. The single frequency network has more excellent frequency use efficiency than a multiple frequency network, and the single frequency network is more advantageous than the multiple frequency network in terms of mobile broadcasting service.

If the frequencies of a plurality of broadcasting signals do not coincide with each other in an overlapping area where two or more of broadcasting signals transmitted by different transmitters are received, a receiver has very low reception performance. In contrast, when the frequencies of broadcasting signals perfectly coincide with each other, the broadcasting signals are recognized as a multi-path signal, thereby reducing an adverse effect on the reception performance of a receiver.

As described above, the reference signal itself of a GPS has good frequency quality, but a reference frequency generated from a GPS receiver has relatively low frequency quality. In other words, the generated reference frequency has more jitter than the reference signal of the GPS, and an instant frequency difference between frequencies generated from different GPS receivers is increased. As a result, there is a problem in that a frequency offset is generated between the transmission signals of a plurality of transmitters.

### PRIOR ART DOCUMENT

### Patent Document

(Patent Document 1) Korean Patent Laid-Open Publication No. 10-2009-0061425 entitled REPEATER AND METHOD FOR PROCESSING SIGNAL AND FOR CONVERTING FREQUENCE THEREOF by ETRI on Jun. 16, 2009

### SUMMARY OF THE INVENTION

An object of the present invention is to provide an apparatus and method for minimizing an instant frequency difference between transmission signals by identically maintaining frequencies between the transmission signals of a plurality of transmitters while using a reference frequency, generated from a reference signal, only in some of the transmitters when the frequencies of the transmission signals are made coincident with each other using the reference signal.

In an aspect, an apparatus for compensating for a frequency offset includes a signal processing unit configured to receive a first frequency signal from a Global Positioning System (GPS) receiver, a local oscillator configured to transfer a second frequency signal to the GPS receiver so that the first frequency signal is generated, and a frequency offset compensation unit configured to receive frequency offset information, obtained when the first frequency signal is generated, from the GPS receiver and remove the frequency offset component of the local oscillator based on the frequency offset information.

The apparatus may further include a frequency conversion unit configured to receive the second frequency signal from the local oscillator and convert the frequency of a transmission signal, transferred within a service network, based on the second frequency signal.

The signal processing unit may perform signal processing on the transmission signal, received from the frequency conversion unit, based on the first frequency signal.

The frequency offset compensation unit removes the frequency offset component of the local oscillator, included in a transmission signal received from the signal processing unit, based on the frequency offset information.

The apparatus may further include a reception unit configured to receive the transmission signal and transfer the transmission signal to the frequency conversion unit and a transmission unit configured to send a transmission signal from which the frequency offset component of the local oscillator has been removed over the service network.

The second frequency signal is a driving signal for a Phase-Locked Loop (PLL) used by the GPS receiver in order to generate the first frequency signal.

In another aspect, a method of compensating for a frequency offset includes transferring a second frequency signal to a GPS receiver so that a first frequency signal is generated, receiving the first frequency signal from the GPS receiver, receiving frequency offset information, obtained when the first frequency signal is generated, from the GPS receiver, and removing the frequency offset component of a local oscillator based on the frequency offset information.

The second frequency signal may be a driving signal for a Phase-Locked Loop (PLL) used by the GPS receiver in order to generate the first frequency signal.

The method may further include converting the frequency of a transmission signal, transferred within a service network, based on the second frequency signal.

Converting the frequency of the transmission signal may include performing signal processing on the frequency-converted transmission signal based on the first frequency signal.

Removing the frequency offset component of the local oscillator includes removing the frequency offset component of the local oscillator, included in the signal-processed transmission signal, based on the frequency offset information.

In yet another aspect, an apparatus for compensating for a frequency offset includes a signal processing unit configured to receive a first frequency signal from a GPS receiver, a local oscillator configured to transfer a second frequency signal to the GPS receiver so that the first frequency signal is generated, and a frequency offset compensation unit configured to receive frequency offset information, obtained when the first frequency signal is generated, from the GPS receiver and remove the frequency offset component of the local oscillator using the frequency offset information and the total amount of the frequency of a transmission signal converted by the local oscillator.

The apparatus may further include a frequency conversion unit configured to receive the second frequency signal from the local oscillator and convert the frequency of a transmission signal, transferred within a service network, based on the second frequency signal.

The total amount of the frequency of the transmission signal converted by the local oscillator may be obtained by adding the frequency offset component of the local oscillator to the total amount of the frequency of a transmission signal converted by the frequency conversion unit.

The frequency offset compensation unit may generate an offset compensation signal using the frequency offset information.

The frequency offset compensation unit may remove the frequency offset component of the local oscillator by adding the offset compensation signal and the total amount of the frequency of the transmission signal converted by the local oscillator.

In further yet another aspect, a method of compensating for a frequency offset includes transferring a second frequency signal of a local oscillator to a GPS receiver so that a first frequency signal is generated, receiving the first frequency signal from the GPS receiver, receiving frequency offset information, obtained when the first frequency signal is generated, from the GPS receiver, calculating the total amount of the frequency of a transmission signal converted by the local oscillator, and removing the frequency offset component of the local oscillator using the frequency offset information and the total amount of the frequency of the transmission signal converted by the local oscillator.

Removing the frequency offset component of the local oscillator may include generating an offset compensation signal using the frequency offset information and removing the frequency offset component of the local oscillator by adding the offset compensation frequency signal and the total amount of the frequency of the transmission signal converted by the local oscillator.

### BRIEF DESCRIPTION OF THE DRAWINGS

FIG. 1 is a diagram conceptually showing an example of a conventional service network including transmitters;

FIG. 2 is a diagram schematically showing the construction of a conventional transmitter;

FIG. 3 is a diagram conceptually showing an example of a service network including transmitters in accordance with an embodiment of the present invention; and

FIG. 4 is a flowchart illustrating a method of compensating for a frequency offset in transmitters in accordance with an embodiment of the present invention.

### DETAILED DESCRIPTION OF THE EMBODIMENTS

The present invention may be modified in various ways and may be implemented to have several embodiments. Specific embodiments of the present invention are illustrated in the drawings and are described in detail in the detailed description.

It is however to be noted that the present invention is not intended to be limited to the specific embodiments, but is intended to include all modifications, equivalents, or substitutions which fall within the spirit and technical scope of the present invention.

Terms, such as the first and the second, may be used to describe various elements, but the elements should not be restricted by the terms. The terms are used to only distinguish one element and the other element from each other. For example, a first element may be named a second element without departing from the scope of the present invention. Likewise, a second element may be named a first element. A term ‘and/or’ includes a combination of a plurality of pertinent and described items or any one of a plurality of pertinent and described items.

When it is said that one element is ‘connected’ or ‘coupled’ with the other element, it should be understood that one element may be directly connected or coupled with the other element, but a third element may exist between the two elements. In contrast, when it is said that one element is ‘directly connected’ or ‘directly coupled’ with the other element, it should be understood that a third element does not exist between the two elements.

The terms used in this application are used to only describe specific embodiments and are not intended to restrict the present invention. An expression of the singular number includes an expression of the plural number unless clearly defined otherwise in the context. In this application, terms, such as ‘comprise’ or ‘have’, are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

All terms used herein, including technical or scientific terms, have the same meanings as those that are typically understood by those skilled in the art, unless otherwise defined. Terms, such as ones defined in common dictionaries, should be constructed as having the same meanings as those in the context of related technology and should not be constructed as having ideal or excessively formal meanings, unless clearly defined in the specification.

Hereinafter, some exemplary embodiments of the present invention are described in detail with reference to the accompanying drawings. In describing the present invention, in order to help general understanding, the same reference numerals designate the same elements throughout the drawings and a redundant description of the same elements is omitted.

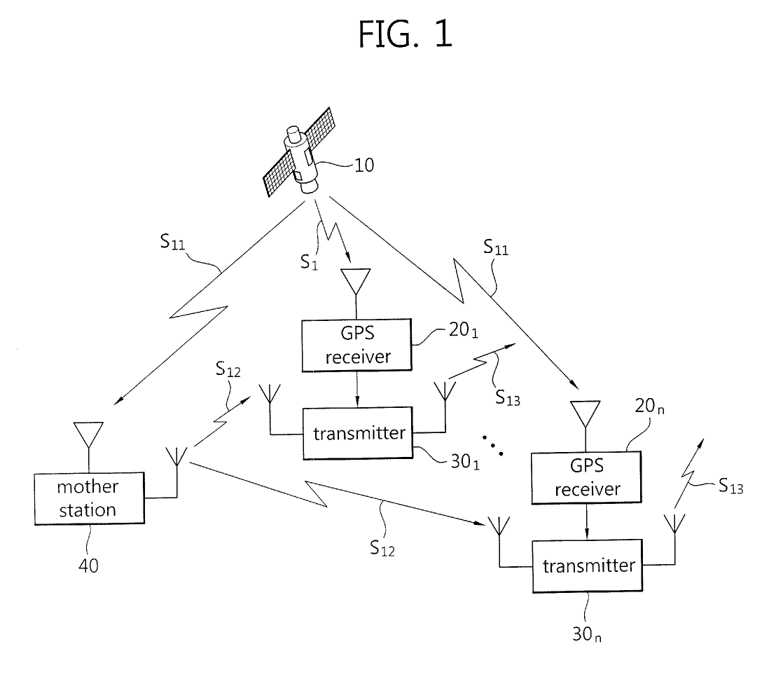

FIG. 1 is a diagram conceptually showing an example of a conventional service network including transmitters.

As shown in FIG. 1, it is assumed that the service network includes a satellite 10, GPS receivers 20₁-20ₙ, and transmitters 30₁-30ₙ. The GPS receivers 20₁-20ₙ are provided to correspond to the respective transmitters 30₁-30ₙ. In this service network, the GPS receivers 20₁-20ₙ, receive a GPS reference signal S₁₁ from the satellite 10 and generate reference frequencies. The GPS receivers 20₁-20ₙ transfer the reference frequencies to the respective transmitters 30₁-30ₙ. Thus, the transmitters 30₁-30ₙ use the reference frequencies as operating frequencies. Here, when a transmission signal S₁₂ is transmitted from a mother station 40 to the transmitters 30₁-30ₙ in a wired or wireless way, the transmitter 30₁-30ₙ receive the transmission signal S₁₂ and send a modulated signal S₁₃ based on the reference frequencies in a wired or wireless way.

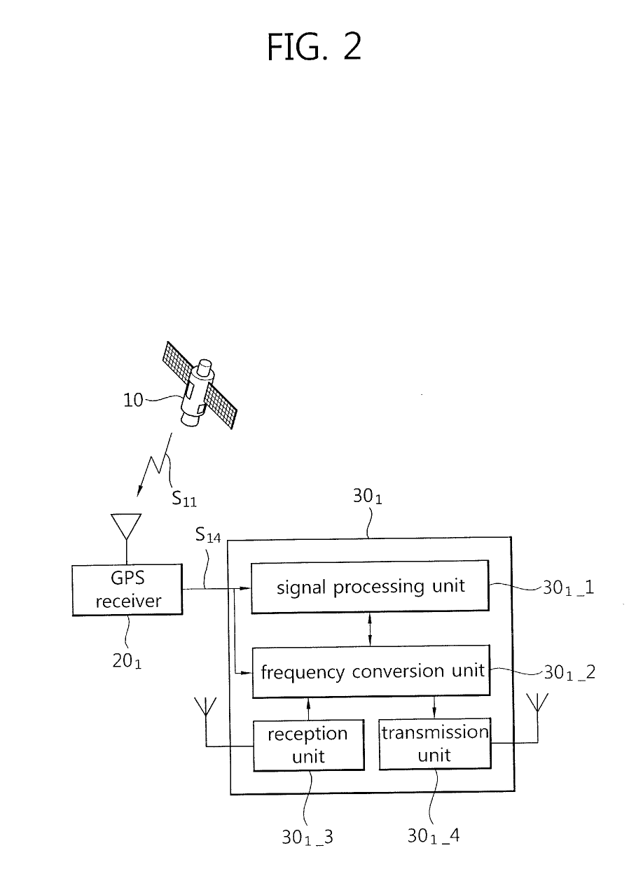

FIG. 2 is a diagram schematically showing the construction of a conventional transmitter. The construction of only the transmitter 30₁ of the transmitters 30₁-30ₙ shown in FIG. 1 is described with reference to FIG. 2.

As shown in FIG. 2, the conventional GPS receiver 20₁ receives the GPS reference signal S₁₁ from the satellite 10 and generates a reference frequency S₁₄. The GPS receiver 20₁ transfers the generated reference frequency S₁₄ to the transmitter 30₁. Here, the reference frequency S₁₄ is generated from the GPS reference signal S₁₁ using a Phase-Locked Loop (PLL). The generated reference frequency S₁₄ has greater jitter than the GPS reference signal S₁₁ in terms of the characteristics of the PLL and thus has deteriorated frequency quality.

The transmitter 30₁ includes a signal processing unit 30₁_{_{—}}1, a frequency conversion unit 30₁_{_{—}}2, a reception unit 30₁_{_{—}}3, and a transmission unit 30₁_{_{—}}4. The signal processing unit 30₁_{_{—}}1 and the frequency conversion unit 30₁_{_{—}}2 of the transmitter 30₁ receive the reference frequency S₁₄ and use the received reference frequency S₁₄ in signal processing and frequency conversion.

As described above, since the reference frequency S₁₄ is used in both the frequency conversion unit 30₁_{_{—}}2 and the signal processing unit 30₁_{_{—}}1 of the conventional transmitter 30₁, the jitter of the reference frequency S₁₄ is increased in proportion to the amount of frequency conversion and thus frequency quality is further deteriorated. Accordingly, there is a problem in that an instant frequency difference between transmission signals within a service network is increased as jitter is increases.

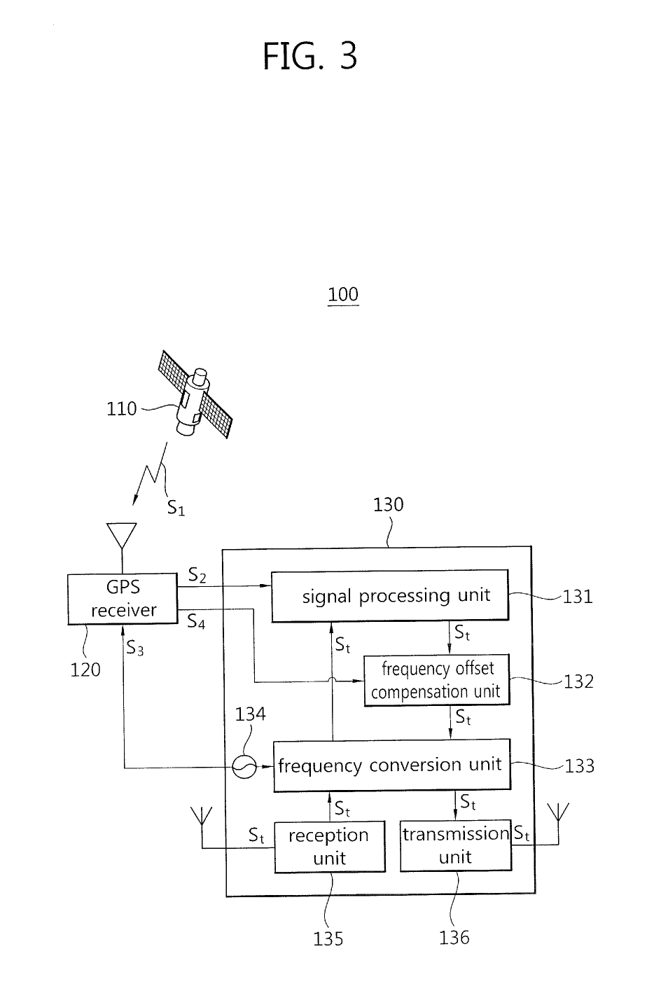

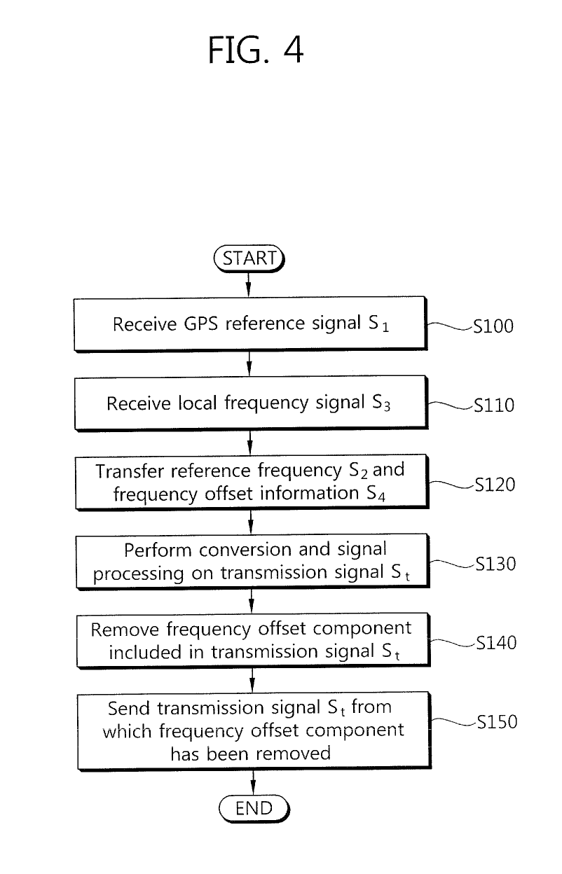

A transmitter for solving the problem in accordance with an embodiment of the present invention is described in detail below with reference to FIGS. 3 and 4.

FIG. 3 is a diagram conceptually showing an example of a service network including transmitters in accordance with an embodiment of the present invention.

As shown in FIG. 3, the service network 100 in accordance with an embodiment of the present invention includes a satellite 110, a GPS receiver 120, and a transmitter 130. In an embodiment of the present invention, only one GPS receiver and one transmitter are illustrated, but the present invention is not limited thereto. One or more GPS receivers and one or more transmitters can be included in the service network.

The satellite 110 sends a GPS reference signal S₁ to the GPS receiver 120.

The GPS receiver 120 generates a reference frequency S₂ using the GPS reference signal S₁. The GPS receiver 120 transfers the reference frequency S₂ to the transmitter 130. Here, a Phase-Locked Loop (PLL) for generating the reference frequency S₂ using the GPS reference signal S₁ in the GPS receiver 120 is driven in response to a local frequency signal S₃ generated from the local oscillator 134 of the transmitter 130. The GPS receiver 120 obtains frequency offset information S₄ for the local oscillator 134 while generating the reference frequency S₂ using the local frequency signal S₃ and transfers the obtained frequency offset information S₄ for the local oscillator 134 to the transmitter 130.

The transmitter 130 can be a frequency offset compensation apparatus for making frequencies between transmission signals within a service network coincident with each other and correcting a frequency offset in order to improve the frequency quality of each transmission signal. The transmitter 130 includes a signal processing unit 131, a frequency offset compensation unit 132, a frequency conversion unit 133, the local oscillator 134, a reception unit 135, and a transmission unit 136.

The signal processing unit 131 receives the reference frequency S₂ from the GPS receiver 120. The signal processing unit 131 performs a signal processing operation based on the reference frequency S₂. The signal processing unit 131 receives a frequency-converted transmission signal Sₜ from the frequency conversion unit 133. The signal processing unit 131 performs a signal processing operation on the transmission signal Sₜ based on the reference frequency S₂. Furthermore, the signal processing unit 131 transfers the signal-processed transmission signal Sₜ to the frequency offset compensation unit 132.

The frequency offset compensation unit 132 receives the frequency offset information S₄ from the GPS receiver 120. Here, the frequency offset information S₄ includes the frequency offset component of the local oscillator 134. The frequency offset compensation unit 132 removes the frequency offset component of the local oscillator 134, included in the transmission signal Sₜ, based on the frequency offset information S₄. The frequency offset compensation unit 132 transfers the transmission signal Sₜ from which the frequency offset component of the local oscillator 134 has been removed to the frequency conversion unit 133.

The frequency conversion unit 133 receives the local frequency signal S₃ necessary for frequency conversion from the local oscillator 134. The frequency conversion unit 133 receives a transmission signal Sₜ from the reception unit 135. The frequency conversion unit 133 performs frequency conversion on the received transmission signal Sₜ based on the local frequency signal S₃. The frequency conversion unit 133 transfers the frequency-converted transmission signal Sₜ to the signal processing unit 131. Meanwhile, the frequency conversion unit 133 receives the transmission signal Sₜ from which the frequency offset component of the local oscillator 134 has been removed from the frequency offset compensation unit 132. The frequency conversion unit 133 transfers the transmission signal Sₜ from which the frequency offset component of the local oscillator 134 has been removed to the transmission unit 136.

The local oscillator 134 transfers the local frequency signal S₃ to the frequency conversion unit 133 so that frequency conversion can be performed on the transmission signal Sₜ. Furthermore, the local oscillator 134 transfers the local frequency signal S₃ to the GPS receiver 120 so that the PLL of the GPS receiver 120 can use the local frequency signal S₃ when the GPS receiver 120 generates the reference frequency S₂ using the GPS reference signal S₁.

The reception unit 135 receives the transmission signal Sₜ from a mother station (not shown) within the service network 100. The reception unit 135 transfers the transmission signal Sₜ to the frequency conversion unit 133.

The transmission unit 136 receives the transmission signal Sₜ from which the frequency offset component of the local oscillator 134 has been removed from the frequency conversion unit 133. The transmission unit 136 sends the transmission signal Sₜ from which the frequency offset component of the local oscillator 134 has been removed to the service network 100 in a wired or wireless way.

A method of making frequencies between the transmission signals of transmitters included in a service network coincident with each other and also minimizing an instant frequency difference is described in more detail below.

The GPS receiver 120 receives the GPS reference signal Sₜ from the satellite 110, and the GPS reference signal S₁ is represented by Equation 1 below. The GPS receiver 120 receives the local frequency signal S₃ from the local oscillator 134, and the local frequency signal S₃ is represented by Equation 2 below.

S₁=fₛₐₜ+Δfₛₐₜ [Equation 1]

S₃=f_{LO}+Δf_{LO} [Equation 2]

In Equations 1 and 2, the components Δfₛₐₜ and Δf_{LO} marked by Δ are frequency offset components and unknown values, and the components fₛₐₜ and f_{LO} not marked by Δ are ideal frequency values.

The GPS receiver 120 restores the GPS reference signal S₁ using the PLL driven in response to the local frequency signal S₃ and generates the reference frequency S₂ using the restored GPS reference signal S₁. Here, the frequency offset information S₄ can be obtained from the PLL, and the obtained frequency offset information S₄ is represented by Equation 3 below.

$${S}_{4} = Δ {f}_{sat} - Δ {f}_{Lo} \cdot \frac{{f}_{sat}}{{f}_{Lo}} \qquad [ Equation 3 ]$$

Meanwhile, the frequency conversion unit 133 performs frequency conversion on the transmission signal Sₜ, received from the reception unit 135, based on the local frequency signal S₃. Here, assuming that the total amount of ideal frequency conversion in the frequency conversion unit 133 is fₜₒₜₐₗ, the total amount of the frequency fₜₒₜₐₗ_{_{—}}_{LO} actually converted by the local oscillator 134 is represented by Equation 4 below.

$${f}_{total\_Lo} = \frac{{f}_{total}}{{f}_{Lo}} \cdot ( {f}_{Lo} - Δ {f}_{Lo} ) = {f}_{total} + Δ {f}_{Lo} \cdot \frac{{f}_{total}}{{f}_{Lo}} \qquad [ Equation 4 ]$$

In Equation 4, tₜₒₜₐₗ is the total amount of ideal frequency conversion in the frequency conversion unit 133, and

$$Δ {f}_{Lo} \cdot \frac{{f}_{total}}{{f}_{Lo}}$$

is the frequency offset component of the local oscillator 134.

In other words, the frequency component of the transmission signal Sₜ transmitted by the transmission unit 136 includes the frequency offset component

$$Δ {f}_{Lo} \cdot \frac{{f}_{total}}{{f}_{Lo}}$$

of the local oscillator 134. If the frequency offset component is removed from the transmission signal Sₜ, the transmission signal Sₜ has the same frequency as other transmission signals within the service network 100.

In order to remove the frequency offset component from the transmission signal Sₜ, the frequency offset compensation unit 132 generates an offset compensation signal S₅ as in Equation 5 by multiplying the frequency offset information S₄ [see Equation 3] by

$$\frac{{f}_{total}}{{f}_{Lo}} .$$

$${S}_{5} = {S}_{4} \cdot \frac{{f}_{total}}{{f}_{sat}} = ( Δ {f}_{sat} - Δ {f}_{Lo} \cdot \frac{{f}_{sat}}{{f}_{Lo}} ) \cdot \frac{{f}_{total}}{{f}_{sat}} = Δ {f}_{sat} \cdot \frac{{f}_{total}}{{f}_{sat}} - Δ {f}_{Lo} \cdot \frac{{f}_{total}}{{f}_{Lo}} \qquad [ Equation 5 ]$$

When the frequency offset component of the local oscillator 134 is removed using the offset compensation signal S₅ as described above, the center frequency component of the transmission signal Sₜ transmitted by the transmission unit 136 is the same as Equation 6 from which the frequency offset component Δf_{LO} of the local oscillator 134 has been removed. That is, the frequency offset compensation unit 132 removes the frequency offset component Δf_{LO} of the local oscillator 134 by adding the offset compensation signal [see Equation 5] to the total amount of the frequency [see Equation 4] actually converted by the local oscillator 134. Accordingly, since a frequency component included in Equation 6 is common to all transmission signals within the service network 100, all the transmission signals have the same frequency.

$$\begin{matrix}{f}_{total\_Lo} + {S}_{5} = ( {f}_{total} + Δ {f}_{Lo} \cdot \frac{{f}_{total}}{{f}_{Lo}} ) + \\ ( Δ {f}_{sat} \cdot \frac{{f}_{total}}{{f}_{sat}} - Δ {f}_{Lo} \cdot \frac{{f}_{total}}{{f}_{Lo}} ) \\ = {f}_{total} + Δ {f}_{sat} \cdot \frac{{f}_{total}}{{f}_{sat}}\end{matrix} \qquad [ Equation 6 ]$$

FIG. 4 is a flowchart illustrating a method of compensating for a frequency offset in transmitters in accordance with an embodiment of the present invention.

Referring to FIGS. 3 and 4, the GPS receiver 120 of the service network 100 in accordance with an embodiment of the present invention receives the GPS reference signal S₁ from the satellite 110 at step S100. The GPS receiver 120 receives the local frequency signal S₃ from the local oscillator 134 of the transmitter 130 at step S110. The GPS receiver 120 generates the reference frequency S₂ using the GPS reference signal S₁ and transfers the generated reference frequency S₂ to the transmission system 130. Here, the PLL of the GPS receiver 120 generates the reference frequency S₂ using the local frequency signal S₃. Furthermore, the GPS receiver 120 transfers the frequency offset information S₄ for the local oscillator 134, obtained while generating the reference frequency S₂, to the transmission system 130 at step S120.

The signal processing unit 131 of the transmission system 130 receives the reference frequency S₂ from the GPS receiver 120. The frequency offset compensation unit 132 receives the frequency offset information S₄ from the GPS receiver 120.

When the transmission signal Sₜ is received from the reception unit 135, the frequency conversion unit 133 performs frequency conversion on the transmission signal Sₜ based on the local frequency signal S₃. The frequency conversion unit 133 transfers the frequency-converted transmission signal Sₜ to the signal processing unit 131. The signal processing unit 131 performs a signal processing operation on the transmission signal Sₜ based on the reference frequency S₂ at step S130. The signal processing unit 131 transfers the signal-processed to transmission signal Sₜ to the frequency offset compensation unit 132.

The frequency offset compensation unit 132 removes the frequency offset component of the local oscillator 134, included in the transmission signal Sₜ, based on the frequency offset information S₄ at step S140. The frequency offset compensation unit 132 transfers a transmission signal Sₜ from which the frequency offset component of the local oscillator 134 has been removed to the transmission unit 136 through the frequency conversion unit 133. The transmission unit 136 sends the transmission signal Sₜ from which the frequency offset component of the local oscillator 134 has been removed in a wired or wireless way at step S150.

In an embodiment of the present invention, a GPS reference signal and a GPS receiver have been illustrated as an example, but the present invention is not limited thereto. The present invention can be extended and applied to reference signals other than a GPS signal and a system using a corresponding receiver.

In accordance with the method and apparatus for compensating for a frequency offset, unlike in the conventional case where a reference frequency generated from a reference signal is used in all transmitters, the local oscillator having high quality is used when frequency conversion is performed, and a reference frequency having low frequency quality is used in some operations, such as the operation of the signal processing unit. Accordingly, the frequency quality of a transmission signal can be improved.

Furthermore, in accordance with an embodiment of the present invention, an instant frequency difference between transmission signals can be minimized by improving the frequency quality of each transmission signal while making transmission signals within a service network have the same frequency.

Although some embodiments of the present invention have been described with reference to the accompanying drawings, it is not intended to limit the scope of the present invention, and a person having ordinary skill in the art may modify the present invention in various forms within the spirit and scope of the present invention determined by the claims.

What is claimed is:

1. An apparatus for compensating for a frequency offset, comprising:
a signal processing unit configured to receive a first frequency signal from a Global Positioning System (GPS) receiver;
a local oscillator configured to transfer a second frequency signal to the GPS receiver so that the first frequency signal is generated; and
a frequency offset compensation unit configured to receive frequency offset information, obtained when the first frequency signal is generated, from the GPS receiver and remove a frequency offset component of the local oscillator based on the frequency offset information.

2. The apparatus of claim 1, further comprising a frequency conversion unit configured to receive the second frequency signal from the local oscillator and convert a frequency of a transmission signal, transferred within a service network, based on the second frequency signal.

3. The apparatus of claim 2, wherein the signal processing unit performs signal processing on the transmission signal, received from the frequency conversion unit, based on the first frequency signal.

4. The apparatus of claim 3, wherein the frequency offset compensation unit removes a frequency offset component of the local oscillator, included in a transmission signal received from the signal processing unit, based on the frequency offset information.

5. The apparatus of claim 2, further comprising:
a reception unit configured to receive the transmission signal and transfer the transmission signal to the frequency conversion unit; and
a transmission unit configured to send a transmission signal from which a frequency offset component of the local oscillator has been removed over the service network.

6. The apparatus of claim 1, wherein the second frequency signal is a driving signal for a Phase-Locked Loop (PLL) used by the GPS receiver in order to generate the first frequency signal.

7. A method of compensating for a frequency offset, comprising:
transferring a second frequency signal to a Global Positioning System (GPS) receiver so that a first frequency signal is generated;
receiving the first frequency signal from the GPS receiver;
receiving frequency offset information, obtained when the first frequency signal is generated, from the GPS receiver; and
removing a frequency offset component of a local oscillator based on the frequency offset information.

8. The method of claim 7, wherein the second frequency signal is a driving signal for a Phase-Locked Loop (PLL) used by the GPS receiver in order to generate the first frequency signal.

9. The method of claim 7, further comprising converting a frequency of a transmission signal, transferred within a service network, based on the second frequency signal.

10. The method of claim 9, wherein converting the frequency of the transmission signal comprises performing signal processing on the frequency-converted transmission signal based on the first frequency signal.

11. The method of claim 10, wherein removing the frequency offset component of the local oscillator comprises removing the frequency offset component of the local oscillator, included in the signal-processed transmission signal, based on the frequency offset information.

12. An apparatus for compensating for a frequency offset, comprising:
a signal processing unit configured to receive a first frequency signal from a Global Positioning System (GPS) receiver;
a local oscillator configured to transfer a second frequency signal to the GPS receiver so that the first frequency signal is generated; and
a frequency offset compensation unit configured to receive frequency offset information, obtained when the first frequency signal is generated, from the GPS receiver and remove a frequency offset component of the local oscillator using the frequency offset information and a total amount of a frequency of a transmission signal converted by the local oscillator.

13. The apparatus of claim 12, further comprising a frequency conversion unit configured to receive the second frequency signal from the local oscillator and convert a frequency of a transmission signal, transferred within a service network, based on the second frequency signal.

14. The apparatus of claim 13, wherein the total amount of the frequency of the transmission signal converted by the local oscillator is obtained by adding the frequency offset component of the local oscillator to a total amount of a frequency of a transmission signal converted by the frequency conversion unit.

15. The apparatus of claim 14, wherein the frequency offset compensation unit generates an offset compensation signal using the frequency offset information.

16. The apparatus of claim 15, wherein the frequency offset compensation unit removes the frequency offset component of the local oscillator by adding the offset compensation signal and the total amount of the frequency of the transmission signal converted by the local oscillator.

17. A method of compensating for a frequency offset, comprising:
transferring a second frequency signal of a local oscillator to a Global Positioning System (GPS) receiver so that a first frequency signal is generated;
receiving the first frequency signal from the GPS receiver;
receiving frequency offset information, obtained when the first frequency signal is generated, from the GPS receiver;
calculating a total amount of a frequency of a transmission signal converted by the local oscillator; and
removing a frequency offset component of the local oscillator using the frequency offset information and the total amount of the frequency of the transmission signal converted by the local oscillator.

18. The method of claim 17, wherein removing the frequency offset component of the local oscillator comprises:
generating an offset compensation signal using the frequency offset information; and
removing the frequency offset component of the local oscillator by adding the offset compensation frequency signal and the total amount of the frequency of the transmission signal converted by the local oscillator.
